(19) United States
(12) Patent Application Publication
(10) Pub. No.: US 2023/0282131 A1
(43) Pub. Date: Sep. 7, 2023

(54) INTELLIGENT TEACHING AID CONTROL SYSTEM AND METHOD USED FOR BUILDING BLOCK PROGRAMMING LEARNING

(71) Applicants: Hainan Normal University, Haikou City, Hainan (CN); Hainan Juyuan Technology Co., Ltd., Haikou City, Hainan (CN)

(72) Inventor: Yi Zhen WANG, Haikou City, Hainan (CN)

(21) Appl. No.: 17/598,492

(22) PCT Filed: May 17, 2021
(86) PCT No.: PCT/CN2021/094011

§ 371 Date: Sep. 27, 2021

(51) Int. Cl. G09B 19/00

(52) U.S. Cl. CPC G09B 19/0053

(57) ABSTRACT

The invention relates to an intelligent teaching aid control system and method used for building block programming learning, the control terminal includes a creation module, a splicing module, a first conversion module, a sending module, a receiving module, a second conversion module, a calculation module, and a display module. The smart teaching aid includes an execution module and a gesture motion detection module, which can facilitate instructors to learn how to control the movement of the smart teaching aid by controlling the splicing of building blocks. The software and hardware interaction is flexible and the teaching is good.

### TECHNICAL FIELD

The present invention relates to the technical field of intelligent teaching aids, in particular to an intelligent teaching aid control system and method used for building block programming learning.

### BACKGROUND

Building block programming is a form of programming Users can write their own programs without memorizing and writing program codes. They only need to select and combine a series of “building blocks” provided by the system to write their own programs, such as Scratch and Blockly. With the rise of graphical programming tools such as scratch and blockly, the market for children's programming education is gradually expanding, followed by the development of teaching aids for children's programming education.

The existing building block programming is used in conjunction with teaching aids to achieve different functions, but the teaching feedback effect is not good. For example, the Chinese patent application, application number 201810679535.4, published on Sep. 4, 2018, discloses the field of electronic building block toys or teaching aids, especially related to programmable learning devices and smart electronic building block devices based on smart building blocks. It includes a device body, a command building block and an action execution device; the command building block is provided with a recording unit; the device body is provided with a main control unit, and the device body is provided with a connection port, and the device body is also provided There is a sending and receiving unit and a display module; the action execution device is provided with a receiving unit; the instruction building block is connected to the connection port and then electrically connected to the main control unit, and the main control unit scans and recognizes the instruction building block on the connection port in turn And call the corresponding instruction signal according to the instruction sequence number information of the instruction block, and transmit the instruction signal to the sending and receiving unit for sending or displaying through the display module, and after the sending and receiving unit sends the instruction signal, the receiving unit of the action execution device receives the instruction Signal and perform corresponding actions. However, this unit mainly downloads the fully formed hardware driver, and cannot feedback the hardware action to generate the building block splicing process so as to teach the students to learn, and the teaching is poor.

### SUMMARY OF THE INVENTION

The embodiment of the present invention provides an intelligent teaching aid control system and method used for building block programming learning, which solves the problem of poor teaching performance of existing smart teaching aids for building block programming learning.

The present invention provides an intelligent teaching aid control system for building block programming learning, comprising: control terminal and intelligent teaching aids, the control terminal includes a creation module, a splicing module, a first conversion module, a sending module, a receiving module, a second conversion module, a calculation module, and a display module. the smart teaching aid including execution module and gesture detection module; the creation module is used to create a building block containing input parameters; the splicing module is used for splicing different building blocks; the first conversion module is used to combine the code sentences corresponding to the blocks after the splicing is completed to generate instruction codes; the sending module is used to send the instruction code to the smart teaching aid; the receiving module is configured to receive posture action information sent by the posture action detection unit; the second conversion module is used to generate a teaching code according to the gesture action, and convert the teaching code into a corresponding combination of building blocks; the calculation module is used to calculate the building blocks, the splicing sequence and the splicing steps required to build the combination of the building blocks; the display module is used to display the splicing steps of the building block combination and the corresponding code; the execution module is configured to receive the instruction code sent by the sending module and execute corresponding actions according to the instruction code; the posture action detection module is used to detect posture action information of the smart teaching aid and send the posture action information to the first receiving module.

Optionally, wherein the control terminal further comprises:

an animation module for generating a motion animation model of the smart teaching aid according to the gesture action;

a decomposition module is used to decompose the motion animation model into a number of animation sub-models corresponding to the state of the splicing step of the combination of the building blocks.

Optionally, the control terminal further comprises:

a freeze module is used to freeze the splicing step of the building block combination;

a running module is used to display the running process of the corresponding animation sub-model in the current splicing step state.

Optionally, the control terminal further comprises:

an operation stack module is used to save the splicing shapes and instruction codes of the blocks generated sequentially in the order of splicing time when splicing different blocks according to the shape attributes of the blocks;

a stacking module is used to save the building block splicing shape and instruction code in different time sequences popped from the operation stack module, and to bounce the building block splicing shape and instruction code to the operation stack when the operation is resumed Module.

Optionally, the building block includes sequential building block, branch building block and circular building block.

Optionally, the sending module is a wireless network sending module.

The present invention also proposes an intelligent teaching aid control method for building block programming learning, comprises:

creating a building block containing input parameters and a conversion unit for converting the building block into a code sentence; the different building blocks are spliced according to the shape attributes of the building blocks, and the conversion unit combines the code statements corresponding to the spliced building blocks to generate instruction codes; sending the instruction code to an intelligent teaching aid, the intelligent teaching aid receives the instruction code and executes corresponding actions according to the instruction code; detecting the posture actions of the smart teaching aid, generating teaching codes according to the posture actions, and converting the teaching codes into corresponding building block combinations; calculate the building block and the splicing sequence required to build the building block combination, and show the splicing process of the building block combination.

Optionally, further comprising: generating a motion animation model of the smart teaching aid according to the gesture action, and decomposing the motion animation model into a number of animation sub-models corresponding to the state of the splicing step of the combination of the building blocks.

Optionally, further comprising: freeze the splicing step of the building block combination, and display the running process of the corresponding animation sub-model in the current splicing step state.

Optionally, when splicing different building blocks according to the shape attributes of the building blocks, the operation stack is used to save the building block splicing shapes and instruction codes that are sequentially generated according to the time sequence of the splicing; using stacking to save the building block splicing shapes and instruction codes in different time sequences popped from the operation stack, and stacking them to the stack to bounce the building block splicing shapes and instruction codes to the operation stack when the operation is resumed.

It can be seen from the above technical solutions that the embodiments of the present invention have the following advantages:

The intelligent teaching aid control system for programming learning of building blocks includes a control terminal and an intelligent teaching aid. The control terminal includes a creation module, a splicing module, a first conversion module, a sending module, a receiving module, a second conversion module, and a calculation module And a display module, the smart teaching aid includes an execution module and a gesture and action detection module, and the smart teaching aid includes an execution module and a gesture and action detection module. On the one hand, the instruction code is generated by combining the code statements corresponding to the building blocks after the splicing is completed, and then the instruction code is sent to the smart teaching aid, and the execution module receives the instruction code sent by the sending module and executes the corresponding action according to the instruction code; On the one hand, the instructor manually controls the action of the smart teaching aid, and then is used to detect the posture action information of the smart teaching aid through the posture action detection module and send the posture action information to the control terminal, and the second conversion module generates teaching based on the posture action Code, and convert the teaching code into the corresponding building block combination, then the calculation module calculates the building block, the splicing sequence and the splicing steps required to build the building block combination, and finally the display module displays the splicing steps of the building block combination and the corresponding On the control terminal, how to control the intelligent teaching aid to realize the disassembly and display of the building block splicing step of the action posture, and can compare the displayed code, which is convenient for teachers to learn how to control the movement of the intelligent teaching aid by controlling the splicing of the building blocks. The software and hardware interaction is flexible and the teaching is good.

### BRIEF DESCRIPTION OF THE DRAWINGS

In order to express the technical solutions of the embodiments of the present invention more clearly, the accompanying drawings required for the description of the embodiments will be briefly introduced below. Obviously, the accompanying drawings in the following description are only some embodiments of the present invention. For those of ordinary skill in the art, without creative work, other drawings can be obtained based on these drawings.

FIG. 1 is a block diagram of the intelligent teaching aid control system in the embodiment of this specification;

FIG. 2 is a flow chart of the method for controlling the smart teaching aid in the embodiment of this specification.

### DETAILED DESCRIPTION

In order to enable those skilled in the art to better understand the solutions of the present invention, the technical solutions in the embodiments of the present invention will be described clearly and completely in conjunction with the accompanying drawings in the embodiments of the present invention. Obviously, the described embodiments are only a part of the embodiments of the present invention, rather than all the embodiments. In order to enable those skilled in the art to better understand the solutions of the present invention, the technical solutions in the embodiments of the present invention will be described clearly and completely in conjunction with the accompanying drawings in the embodiments of the present invention. Obviously, the described embodiments are only a part of the embodiments of the present invention, rather than all the embodiments.

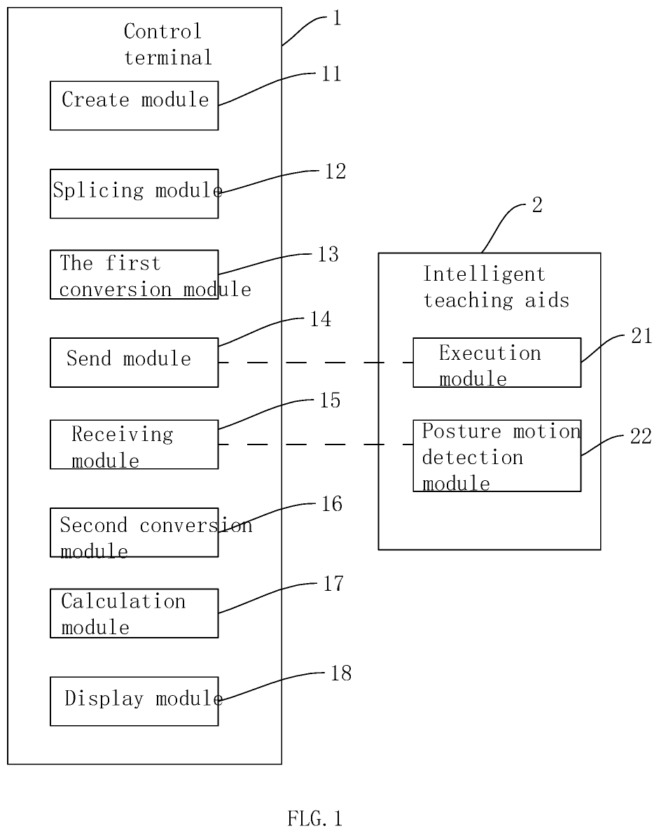

Please refer to FIG. 1, the present invention provides an intelligent teaching aid control system for building block programming learning, Including the control terminal 1 and the smart teaching aid 2. The control terminal 1 includes a creation module 11, a splicing module 12, a first conversion module 13, a sending module 14, a receiving module 15, a second conversion module 16, a calculation module 17 and a display module 18. The teaching aid 2 includes an execution module 21 and a gesture detection module 22. The smart teaching aid 2 includes an execution module 21 and a gesture detection module 22; the creation module 11 is used to create blocks containing input parameters; the splicing module 12 is used to combine different blocks Perform splicing; the first conversion module 13 is used to combine the code sentences corresponding to the blocks after the splicing is completed to generate instruction codes; the sending module 14 is used to send the instruction codes to the smart teaching aid 2; the receiving module 15 is used to receive gesture motion detection The posture action information sent by the unit; the second conversion module 16 is used to generate the teaching code according to the posture action and convert the teaching code into the corresponding building block combination; the calculation module 17 is used to calculate the building block and splicing required to build the building block combination Sequence and splicing steps; the display module 18 is used to display the splicing steps of the building block combination and the corresponding code; the execution module 21 is used to receive the instruction code sent by the sending module 14 and perform corresponding actions according to the instruction code; the posture action detection module 22 is used to The posture action information of the smart teaching aid 2 is detected and the posture action information is sent to the first receiving module 15.

In this embodiment, the control terminal 1 includes, but is not limited to, smart phones, personal digital assistants, desktop computers, notebook computers, and tablet computers, and the smart teaching aids 2 include smart cars, smart robots, display screens, LED lamp beads, and the like. Taking a smart car as an example, the execution module 21 is a wheel drive motor of the smart car and a mechanism that controls the direction of the wheels, and the posture motion detection module 22 is a group of posture sensors installed on the wheels. In this embodiment, on the one hand, the creation module 11 creates a building block containing input parameters. The input parameters may refer to parameters for controlling the corresponding smart car to achieve different functions through the building block. If the input parameter is a block with “move one meter to the left”, the block can control the smart car to turn left and then move forward one meter. By combining the code statements corresponding to the completed building blocks, the instruction codes are generated. These code instructions are used to control the smart car to perform a series of actions, and then send the instruction codes to the smart teaching aid 2, and the execution module 21 receives the instructions sent by the sending module 14. After the instruction code, the corresponding action is executed according to the instruction code; on the other hand, the movement of the intelligent teaching aid 2 can also be manually controlled and the corresponding building block combination and code can be generated in the control terminal 1, which is convenient for teaching and learning. Specifically, the instructor manually controls the actions of the smart car, such as moving along a square trajectory for one week, and then uses the posture action detection module 22 to detect the posture action information of the smart car, such as forward distance, forward direction, and forward speed, and send the posture action information For the control terminal 1, the second conversion module 16 generates the teaching code according to the posture action, and converts the teaching code into the corresponding building block combination, and then the calculation module 17 calculates the building blocks, the splicing sequence and the splicing steps required to build the building block combination. Finally, the display module 18 displays the splicing steps of the building block combination and the corresponding codes. On the control terminal 1, how to control the smart teaching aid 2 realizes the disassembly and display of the building block splicing steps of the action posture, and can compare the displayed codes to facilitate the instructor to learn how By controlling the splicing of building blocks to control the movement of the intelligent teaching aid 2, the software and hardware interaction is flexible and the teaching is good.

As a further improvement to the above-mentioned embodiment, the control terminal 1 further includes an animation module, which is used to generate a motion animation model of the intelligent teaching aid 2 according to posture actions. The decomposition module is used to decompose the motion animation model into a number of animation sub-models corresponding to the state of the splicing step of the combination of building blocks. The freeze module is used to freeze the splicing step of the block combination; the running module is used to display the running process of the corresponding animation sub-model in the current splicing step state. In this embodiment, the movement process of the smart teaching aid 2 and the corresponding block combination can be displayed step by step, which plays a role of comparing the block combination and the movement process of the hardware, which is convenient for the teacher to learn block programming

In a further embodiment, the control terminal 1 further includes: an operation stack module, which is used to store the splicing shapes and instruction codes of the blocks generated in sequence according to the time sequence of splicing when the different blocks are spliced according to the shape attributes of the blocks; a stacking module is used to save the building block splicing shape and instruction code in different time sequences popped from the operation stack module, and to bounce the building block splicing shape and instruction code to the operation stack module when the operation is resumed. When the user needs to cancel a splicing step and return to the previous step, he only needs to return the block splicing shape and instruction code stored in the operation stack module to the stacking module for storage;

When it is necessary to cancel the undo, the splicing shape and instruction code of the building blocks stacked in the stack module are bounced back to the operation stack module. The undo operation and restoration operation of the splicing step can be realized through the operation stack module and the stack-in-stack module, and repeated splicing and modification can be carried out conveniently.

Further, as a further improvement to the above embodiment, the building block includes a sequential building block, a branch building block, and a cyclic building block. For sequential building blocks, the integrated program codes of sequential building blocks can be executed in sequence according to the order of the codes; for branch building blocks, the integrated program codes of branch building blocks can be judged according to specific logical operations, and according to the judgment result Execute different codes, For example, the program code integrated by the branch building block can include if statement and switch statement, but not limited to this; For the loop building block, the program code integrated by the loop building block can repeatedly execute a certain piece of program code when the loop condition is met. The code that is repeatedly executed can be called a loop body statement; when the loop condition is not satisfied, The loop ends.

Further, in the embodiment of the present invention, the sending module 14 is a wireless network sending module 14, which realizes the communication connection between the control terminal 1 and the smart teaching aid 2 through a local area network.

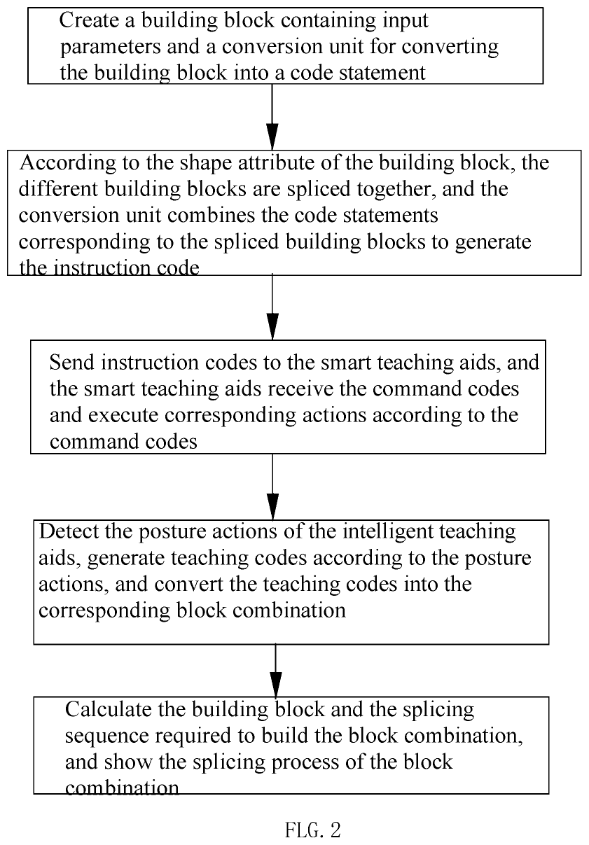

Referring to FIG. 2, the present invention also proposes an intelligent teaching aid control method for building block programming learning, which includes the following steps: creating a building block containing input parameters and a conversion unit for converting the building block into a code sentence; the different building blocks are spliced according to the shape attributes of the building blocks, and the conversion unit combines the code statements corresponding to the spliced building blocks to generate instruction codes; sending the instruction code to an intelligent teaching aid, the intelligent teaching aid receives the instruction code and executes corresponding actions according to the instruction code; detecting the posture actions of the smart teaching aid, generating teaching codes according to the posture actions, and converting the teaching codes into corresponding building block combinations; calculate the building block and the splicing sequence required to build the building block combination, and show the splicing process of the building block combination.

Further, as a further improvement to the above-mentioned embodiment, further comprising: generating a motion animation model of the smart teaching aid according to the gesture action, and decomposing the motion animation model into a number of animation sub-models corresponding to the state of the splicing step of the combination of the building blocks.

Further, as a further improvement to the above-mentioned embodiment, further comprising: freeze the splicing step of the building block combination, and display the running process of the corresponding animation sub-model in the current splicing step state.

Further, as a further improvement to the above-mentioned embodiment, when splicing different building blocks according to the shape attributes of the building blocks, the operation stack is used to save the building block splicing shapes and instruction codes that are sequentially generated according to the time sequence of the splicing; using stacking to save the building block splicing shapes and instruction codes in different time sequences popped from the operation stack, and stacking them to the stack to bounce the building block splicing shapes and instruction codes to the operation stack when the operation is resumed.

Those skilled in the art can clearly understand that, for the convenience and conciseness of the description, the corresponding process in the above described method embodiment can be referred to the specific working process in the foregoing system embodiment. The functions and effects are also the same, and will not be repeated here. Go into details.

The terms “first”, “second”, “third”, “fourth”, etc. (if any) in the specification of the present invention and the above-mentioned drawings are used to distinguish similar objects, but not necessarily used to describe specific Order or precedence. It should be understood that the data used in this way can be interchanged under appropriate circumstances, so that the embodiments of the present invention described herein can be implemented in a sequence other than those illustrated or described herein, for example. In addition, the terms “including” and “having” and any variations of them are intended to cover non-exclusive inclusions. For example, a process, method, system, product, or device that includes a series of steps or units is not necessarily limited to those clearly listed. Those steps or units may include other steps or units that are not clearly listed or are inherent to these processes, methods, products, or equipment.

In the several embodiments provided by the present invention, it should be understood that the disclosed system, device, and method may be implemented in other ways. For example, the device embodiments described above are merely illustrative, for example, the division of units is only a logical function division, and there may be other divisions in actual implementation, for example, multiple units or components can be combined or integrated. To another system, or some features can be ignored, or not implemented. In addition, the displayed or discussed mutual coupling or direct coupling or communication connection may be indirect coupling or communication connection through some interfaces, devices or units, and may be in electrical, mechanical or other forms.

The units described as separate components may or may not be physically separate, and the components displayed as units may or may not be physical units, that is, they may be located in one place, or they may be distributed on multiple network units. Some or all of the units may be selected according to actual needs to achieve the objectives of the solutions of the embodiments.

In addition, the functional units in the various embodiments of the present invention may be integrated into one processing unit, or each unit may exist alone physically, or two or more units may be integrated into one unit. The above-mentioned integrated unit can be implemented in the form of hardware or software functional unit.

If the integrated unit is implemented in the form of a software functional unit and sold or used as an independent product, it can be stored in a computer readable storage medium. Based on this understanding, the technical solution of the present invention essentially or the part that contributes to the existing technology or all or part of the technical solution can be embodied in the form of a software product, and the computer software product is stored in a storage medium. Including several instructions to make a computer device (which can be a personal computer, a server, or a network device, etc.) execute all or part of the steps of the method described in each embodiment of the present invention. The aforementioned storage media include: U disk, mobile hard disk, read-only memory (English full name: Read-Only Memory, English abbreviation: ROM), random access memory (English full name: Random Access Memory, English abbreviation: RAM), magnetic Various media that can store program codes, such as discs or optical discs.

As mentioned above, the above embodiments are only used to illustrate the technical solutions of the present invention, not to limit them; although the present invention has been described in detail with reference to the foregoing embodiments, those of ordinary skill in the art should understand that: The technical solutions recorded in the embodiments are modified, or some of the technical features are equivalently replaced; and these modifications or replacements do not cause the essence of the corresponding technical solutions to deviate from the spirit and scope of the technical solutions of the embodiments of the present invention.

1. An intelligent teaching aid control system used for building block programming learning, comprising: control terminal and intelligent teaching aids, the control terminal includes a creation module, a splicing module, a first conversion module, a sending module, a receiving module, a second conversion module, a calculation module, and a display module. the smart teaching aid including execution module and gesture detection module;
the creation module is used to create a building block containing input parameters;
the splicing module is used for splicing different building blocks;
the first conversion module is used to combine the code sentences corresponding to the blocks after the splicing is completed to generate instruction codes;
the sending module is used to send the instruction code to the smart teaching aid;
the receiving module is configured to receive posture action information sent by the posture action detection unit;
the second conversion module is used to generate a teaching code according to the gesture action, and convert the teaching code into a corresponding combination of building blocks;
the calculation module is used to calculate the building blocks, the splicing sequence and the splicing steps required to build the combination of the building blocks;
the display module is used to display the splicing steps of the building block combination and the corresponding code;
the execution module is configured to receive the instruction code sent by the sending module and execute corresponding actions according to the instruction code;
the posture action detection module is used to detect posture action information of the smart teaching aid and send the posture action information to the first receiving module.

2. The intelligent teaching aid control system for programming learning of building blocks of claim 1, wherein the control terminal further comprises:
an animation module for generating a motion animation model of the smart teaching aid according to the gesture action;
a decomposition module is used to decompose the motion animation model into a number of animation sub-models corresponding to the state of the splicing step of the combination of the building blocks.

3. The intelligent teaching aid control system for programming learning of building blocks of claim 2, the control terminal further comprises:
a freeze module is used to freeze the splicing step of the building block combination;
a running module is used to display the running process of the corresponding animation sub-model in the current splicing step state.

4. The intelligent teaching aid control system for programming learning of building blocks of claim 1, the control terminal further comprises:
an operation stack module is used to save the splicing shapes and instruction codes of the blocks generated sequentially in the order of splicing time when splicing different blocks according to the shape attributes of the blocks;
a stacking module is used to save the building block splicing shape and instruction code in different time sequences popped from the operation stack module, and to bounce the building block splicing shape and instruction code to the operation stack when the operation is resumed Module.

5. The intelligent teaching aid control system for programming learning of building blocks of claim 1, the building block includes sequential building block, branch building block and circular building block.

6. The intelligent teaching aid control system for programming learning of building blocks of claim 1, the sending module is a wireless network sending module.

7. An intelligent teaching aid control method for building block programming learning, comprises:
creating a building block containing input parameters and a conversion unit for converting the building block into a code sentence;
the different building blocks are spliced according to the shape attributes of the building blocks, and the conversion unit combines the code statements corresponding to the spliced building blocks to generate instruction codes;
sending the instruction code to an intelligent teaching aid, the intelligent teaching aid receives the instruction code and executes corresponding actions according to the instruction code;
detecting the posture actions of the smart teaching aid, generating teaching codes according to the posture actions, and converting the teaching codes into corresponding building block combinations;
calculate the building block and the splicing sequence required to build the building block combination, and show the splicing process of the building block combination.

8. The intelligent teaching aid control method for building block programming learning of claim 7, further comprising: generating a motion animation model of the smart teaching aid according to the gesture action, and decomposing the motion animation model into a number of animation sub-models corresponding to the state of the splicing step of the combination of the building blocks.

9. The intelligent teaching aid control method for building block programming learning of claim 8, further comprising: freeze the splicing step of the building block combination, and display the running process of the corresponding animation sub-model in the current splicing step state.

10. The intelligent teaching aid control method for building block programming learning of claim 9, when splicing different building blocks according to the shape attributes of the building blocks, the operation stack is used to save the building block splicing shapes and instruction codes that are sequentially generated according to the time sequence of the splicing; using stacking to save the building block splicing shapes and instruction codes in different time sequences popped from the operation stack, and stacking them to the stack to bounce the building block splicing shapes and instruction codes to the operation stack when the operation is resumed.
